(19) United States
(12) Patent Application Publication
(10) Pub. No.: US 2005/0076003 A1
(43) Pub. Date: Apr. 7, 2005

(54) Method and apparatus for delivering personalized search results

(76) Inventors: Paul A. DuBose, Durham, NC (US); Gary J. Gagnon, Fairfield, IA (US); Mark Glick, Chapel Hills, NC (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/891,959

(22) Filed: Jul. 14, 2004

Related U.S. Application Data
(60) Provisional application No. 60/508,854, filed on Oct. 6, 2003.

(51) Int. Cl. G06F 7/00

(52) U.S. Cl. 707/1

(57) ABSTRACT

A process for sorting results returned in response to a search query according to learned associations between one or more prior search query search terms and selected results of said prior search queries.

### RELATED APPLICATION

This application is related to and hereby claims the priority benefit of U.S. Provisional Patent Application No. 60/508,854, entitled “Personalized sorting of internet search engine results based on learned associations between queries and selected results”, filed October 6, 2003 by the present inventor and incorporated herein by reference.

### FIELD OF THE INVENTION

The present invention relates to systems and methods for sorting results returned by search engines, and in particular Internet search engines, in response to queries posed by a user so as to rank the results according to learned associations between terms present in previous searches executed by the user (or, a group of users) and results selected by the user (or group of users) from those previous searches. Other embodiments of the present invention provide systems and methods for returning highly personalized advertising results in response to search queries.

### BACKGROUND

Internet search engines and directories have become ubiquitous, and perhaps indispensable, tools by which users locate and navigate to Internet-based resources accessible via the World Wide Web. According to recent studies, two-thirds to three-quarters of all users cite finding information as one of their primary uses of the Internet and more than 98% of active Web users rely on the Internet to find reference material, 30% on a daily basis and a further 40% on a weekly basis.

Currently when a query is made, a fixed algorithm at the search engine site scores relevant results and the order of results shown to the user is based on sorting the scores from that algorithm. Thus if two people typed in the same query, they would both be presented with the identical ordering of results. Further if an individual typed in a query and selected a result of interest and then retyped the same query, that individual would be presented with the same order of results again, despite having provided feedback to the search engine site on which results are of most interest. Since a typical query may easily generate hundreds or even thousands of results, the ordering of the results for presentation to the user is critical for the search to be effective.

In some cases, the ranking of results returned in response to search queries is influenced by advertisers that pay for prominent placement within returned search result lists. That is, it has become common practice for search engine providers to offer advertisers the opportunity to “purchase” key words or other descriptors such that references to the advertisers' Web sites will be given positions of prominence in the returned search results list when either the search query itself contains one or more of the key words or when the search results contain the key words. While this form of ranked search result list may prove beneficial to an advertiser (e.g., by influencing the amount of traffic directed to the advertiser's Web site), it often provides little or no value to the user because the search results are customized to the advertiser's desires and not the interests of the user. Hence, it would be desirable to provide a system and method that returned search results that are ranked or otherwise ordered according to a user's interests or likely interests, rather than the desires of a third party.

### SUMMARY OF THE INVENTION

In view of the limitations now present in the prior art, the present invention provides new and useful systems and methods for personalized sorting of results from an Internet (or other, e.g., an enterprise) search engine through learned associations between query wording and selected results.

In one embodiment, the present invention provides a process for sorting results returned in response to a search query according to learned associations between one or more prior search query search terms and selected results of said prior search queries. The results returned in response to the search query may be, in varying embodiments, returned from a publicly accessible search engine (e.g., an Internet search engine) or a private search engine (e.g., a search engine deployed within an enterprise network). In still other cases, the search engine may be deployed within a single computer resource (e.g., a personal computer, a PDA, etc.). Although generally the results returned in response to the search query may include any form of results (e.g., results indicative of Web sites, computer files, documents, images, movies, or other results), in one particular embodiment the results comprise advertisements and/or promotional messages. Thus, the present invention is suitable for use as a component of an advertisement placement system that is useful for delivering highly targeted ads/promotional messages to users. Such advertisements may be targeted on the basis of their relevance to the user's likely search goal (as determined according to comparisons with the learned associations) and/or on the basis of search vocabularies that are constructed based on interactions with multiple users. In the latter case, it may be the content of the advertisement that is selected in response to a ranking generated through comparisons with the learned associations.

In general, the results returned in response to the search query may be ranked for presentation to a user. Such ranking may result in the search results being displayed in any of several fashions, such as an ordered list, a matrix or other arrangement in which preferred placement zones within the matrix are given over to highly ranked search results, a graphical layout in which rankings are used to differentiate the search results on the basis of color or another indicator, and so on. Moreover, the learned associations may be constructed according to similarities between the one or more prior search query search terms and elements of the selected results of said prior search queries, for example similarities based on text patterns. Alternatively, or in addition, the learned associations between the one or more prior search query search terms and the selected results of the prior search queries may be based on textual and/or contextual (e.g., key words in context) associations between a user's search vocabulary and the user's selection of previously returned results of searches using terms included therein. Older associations may become less important over time (i.e., the present invention may “forget” such older associations in favor of newer associations). In the case of contextual associations, the learned associations may be based on contextual locations of the prior search query search terms within the selected results of said prior search queries. Furthermore, the search vocabularies may be organized so as to be indicative of a frequency of matched key words and associated query words.

The selected results of the prior search queries generally include results selected for further review by a user. For example, these may be Web sites (or all or some of the content of such sites) visited by the user after executing the prior search queries. Stated differently, these results may be indicative of the choices that a user made concerning the output provided by a personalized search engine.

In a further embodiment, the present invention provides a process for ranking results returned in response to a new search query according to learned associations between attributes of prior search queries and attributes of search results returned in response to said prior search queries that were selected for further investigation. The learned associations may be accessed from an associative memory configured to store same in such a fashion that newer ones of the learned associations replace older ones of the learned associations according to user defined criteria for such replacements. The attributes of the prior search queries may include words, groups of words, categories of words, or other structured or unstructured information such as color or location of information or number and type of images, and may be obtained from snippets of Web sites provided by the search engine or by directly parsing Web sites gleaned from the returned search engine sites. The results may be presented in ranked order, either alone or in combination with one or more suggestions for modified versions of the new search query and/or further lists of ranked search results obtained for such modified versions of the new search query. These and other features of the present invention will be more fully described below.

### BRIEF DESCRIPTION OF THE DRAWINGS

The present invention is illustrated by way of example, and not limitation, in the figures of the accompanying drawings, in which:

FIG. 1 illustrates a software architecture that includes a personal search engine and associated search vocabularies, user interfaces and search router(s) configured in accordance with an embodiment of the present invention.

FIG. 2 illustrates an example of a search result returned by an Internet search engine.

### DETAILED DESCRIPTION

Described herein are systems and methods for sorting results from current Internet searches based on learned associations between textual (or contextual) contents of prior search queries and selected results of those prior queries. To understand the benefits provided by such systems and methods, consider that each Internet user has individual research interests when searching the Internet for information and a fixed search engine algorithm that presents the same ordering of results for each user and does not learn from previous user selections provides less than optimal search results for all users. The same is true for searchers engaged in non-Internet based searches for information. By employing the present systems and methods, however, users are afforded with highly personalized results to Internet (or other computer-based) queries based on their previous interactions with results returned in response to prior queries.

Further embodiments of the present invention also permit the return of highly personalized advertising results in response to search queries. That is, in addition to or in lieu of other forms of search results that might be returned, embodiments of the present invention may be configured to return advertisements or other forms of commercial content that are determined to be highly relevant to a user's current search query based on the user's previous interactions with results returned in response to prior queries. Of course, the converse is also true. That is, some embodiments of the present invention may include filters that exclude these forms of commercial content from the search results.

A variation on this aspect of the present invention is found in embodiments that permit advertisers and others to utilize the personalization features of the present invention to determine advertisement wording or other content (or, indeed, other contextual information such as advertisement placement, size, etc.) that is likely to be of the most interest (and perhaps value) to individual users or groups of users. Using a system to create advertisement content and meta-content with high relevancy scores for designated search queries may allow these advertisers to develop optimal advertisements using the group memory and association results of the present invention. Since these concepts can apply to real products or virtual products, the advertisers may use such association results to determine combinations of product features that are likely to be of most interest and value to a group of users. The associations between user queries, selected items and advertisements could be utilized as a virtual focus group for advertising and product planning, advertisement development and advertisement placement, which may benefit both users and suppliers by providing personalized marketing and product service.

Still other embodiments of the present invention may be configured to return suggestions for modifying search query terms or strings based on learned associations with prior search query terms and selected results. That is, embodiments of the present invention may return not only ranked results in response to user queries, but also offer suggestions for modifying the search queries, through inclusion of new search words and optionally utilizing advanced search features, in order to return ranked lists of results that may even be of higher relevance to the searcher. Such features may even be automated so that multiple search queries can be run and the results therefor ranked and returned to a user in a format that allows the user to see the different ranked lists for the different search strings at a single glance (or perhaps in multiple page views). Such features may permit users to quickly locate the content of interest even when having submitted a less than optimally structured search query.

In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Further, it should be remembered that some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, signals, datum, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented by an apparatus for performing the operations herein, which in some cases may be a computer system specially constructed for the required purposes. In other instances, the apparatus may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

With the above-mentioned principles in mind, consider now a personalized search engine experience, and in particular one in which results of search queries are sorted according to learned associations between one or more search terms or strings used in prior search queries and selected results (i.e., those results chosen by a user for further review) of those prior search queries. Most current methods of learning or adapting from historical data rely on techniques utilizing mathematics that are based on numerical or categorical values or methods to derive numerical or categorical values. In contrast, the present invention allows for personalizing search results utilizing unique associations based on free text information or structured data, and has few constraints on the number of words either in the user query or in the result summaries.

This personalization of returned search results may be performed either at a client site (e.g., an individual user's personal computer or other device which accesses an Internet or other search engine) or at a host site (e.g., a search engine provider's site or other gateway thereto). Performing the personalization at a host site may be particularly advantageous in that it provides an opportunity for a service provider (which in some cases may be an enterprise to which the user belongs) to gather information concerning user associations and preferences, allowing for even further customization of the search results as well as marketing and other opportunities. Of course some users may not wish to share such information with service providers, in which case group profiles or search vocabularies may be used in place of personal profiles/vocabularies in order to preserve some degree of anonymity. Alternatively, the software for sorting the results may reside on the user's computer thereby giving the user more privacy and control of the learned associations.

By introducing a personalized way to sort a potentially large number of results returned by a search query the present invention provides an efficient method of searching the Internet or another information resource (e.g., a library database or other resource) for information. The personalization is achieved, in one embodiment of the present invention, by incorporating associations learned from a user's prior queries and presenting results returned in response to a current search in a sorted/ranked order so that the results likely to be of highest interest to the user are shown first. Regardless of where it is deployed, software which implements an embodiment of the present invention may capture and review each set of results returned by a search query in order to re-rank the results according to a preferred order determined, at least in part, on the information revealed through the learned associations.

Where the number of search results may be very large, the software may flexibly set a maximum number of returns to capture and review. Regardless of whether or not such a filter is used, the software utilizes prior learned associations to sort the incoming results from a current search query by inspecting each result and computing a result score indicating likely user interest. Systems especially suitable for such computations include associative memories (which allow for the use of very large databases) developed by third parties such as Saffron Technology, Inc. and described in U.S. Pat. No. 6,581,049, incorporated herein by reference.

Briefly, an associative memory is a mechanism that allows computer applications to discover, store and retrieve associations between items. In one embodiment of the present invention, the items are search queries and previously selected results of those queries. Unlike a relational database that stores, records and uses rigid indexed-based searching or SQL-based queries, associative memories store associations representing relationships of items in a specific context. Consequently, associative memories (which may be regarded as mechanisms to capture learned associations) allow for so-called “knowledge discovery” based on associative lookups. Associative lookups are based on similarity or proximity as opposed to more explicit characteristics required by indexed-based lookups.

In practice, associative memories are often implemented as a form of content addressable memories, in which the object (content) forms the address used to read and write. Much like a hash key is used to compute a bucket in which an object may be stored in a hash table, an associative memory constructs indices based on attribute vectors to determine associations between objects stored therein. Thus, an associative memory employs a mechanism similar to a co-occurrence matrix in that it stores counts of how items and their respective attributes occur together.

In various embodiments of the present invention, the computations on which the learned associations are to be made may be based on a free text input from the user (i.e., the user's search query, whether considered as individual words, strings or groups of words, categories of words, etc.), computer generated text to develop optimal advertisements and products, and a history of the user's interaction or group of users interactions with or selection of result summaries from prior search queries. The more similar a result is to a previously selected result for a give search query, the higher the score will be.

Thus, the present invention provides a process for sorting results returned in response to a search query according to learned associations between one or more prior search query search terms and selected results of those prior search queries. These techniques are equally applicable to results returned by publicly accessible search engines (e.g., Internet search engines) or private search engines (e.g., search engines deployed within enterprise networks) or within individual computer resources (e.g., application servers, personal computers, PDAs, etc.). Although generally the results returned in response to the search query may include any form of results (e.g., results indicative of Web sites, computer files, documents, images, movies, or other results), in one particular embodiment the results comprise advertisements.

Where advertisements are concerned, the present invention is suitable for use as a component of an advertisement placement system geared for delivering highly targeted ads to users. Such advertisements may be targeted on the basis of their relevance to the user's likely search goal (as determined according to comparisons with the learned associations) and/or on the basis of search vocabularies that are constructed based on interactions with multiple users. In the latter case, it may be the content of the advertisement that is selected in response to a ranking generated through comparisons with the learned associations.

In general, the results returned in response to the search query may be ranked for presentation to a user. Such ranking may result in the search results being displayed in any of several fashions, such as an ordered list, a matrix or other arrangement in which preferred placement zones within the matrix are given over to highly ranked search results, a graphical layout in which rankings are used to differentiate the search results on the basis of color or another indicator, and so on. Moreover, the learned associations may be constructed according to similarities between the one or more prior search query search terms and elements of the selected results of the prior search queries, for example similarities based on text patterns. Alternatively, or in addition, the learned associations between the one or more prior search query search terms and the selected results of the prior search queries may be based on textual and/or contextual associations between a user's search vocabulary and the user's selection of previously returned results of searches using terms included therein. Older associations may become less important over time (i.e., the present invention may “forget” such older associations in favor of newer associations). In the case of contextual associations, the learned associations may be based on contextual locations of the prior search query search terms within the selected results of said prior search queries. Furthermore, the search vocabularies may be organized so as to be indicative of a frequency of matched key words and associated query words

The selected results of the prior search queries generally include results selected for further review by a user. For example, these may be Web sites (or all or some of the content of such sites) visited by the user after executing the prior search queries or information regarding a sales event that is presented after a user clicks on an advertisement. Stated differently, these results may be indicative of the choices that a user made concerning the output provided by a personalized search engine.

Where the methods described herein are embodied in computer software, such software may “learn” whenever a new search result is selected by reinforcing the text patterns between the user query that resulted in the result being returned and the selected item. The user may also choose to use negative reinforcement by indicating a result has a very low interest level and he/she wants to avoid similar sites in the future. Alternatively, or in addition, users may indicate multidimensional levels of interest such as low, medium or high interest. These levels of interest may be indicated in any of several fashions, such as user scorecards, check boxes arranged to correspond to the search results and so on; and either at the time the results are originally returned or subsequent thereto. As indicated above, the present invention incorporates the capability of forgetting old interests over time so that as the user changes interest or levels of interest, the software can adapt to the new interest patterns. Such “forgetfulness” may be instantiated as a time-based filter that either reduces the importance given to older associations and/or simply deletes them from the associative memory.

The user may also choose to have a directory of associations so that different learning may be used for different areas of research. For example a hobby may merit one set of associations while various professional topics may each merit their own set of associations. This ability to differentiate groups of learned associations allows for even more personalization of results in the context of a current search. For example, a time-based methodology may be employed so that it is presumed for searches executed during a user's regular business hours, the results of those searches should be organized according to associations stored in the user's “work” association. For searches executed outside those business hours, it may be presumed that a “leisure” association should be consulted when ranking the search results. The system may also determine which set of associations is most relevant for a specific query. Such default search result ranking schemes may of course be overridden by manual inputs that can alter the association to be used when ranking the search results.

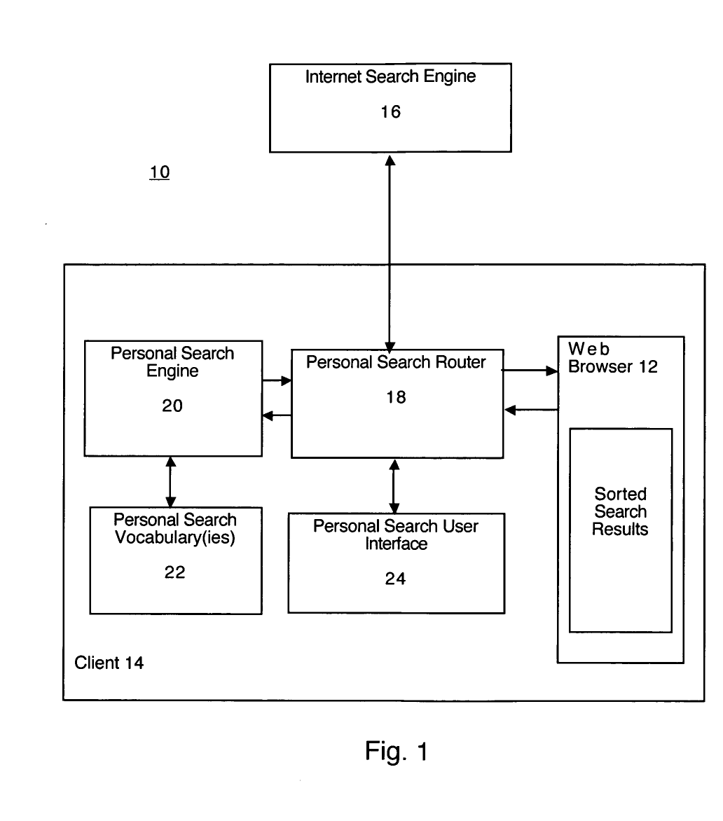

Turning now to FIG. 1, a software architecture 10 within which an embodiment of the present invention may be instantiated is illustrated. It should be appreciated that this illustration is being used solely as an example in order to provide the reader with a better understanding of the present invention. In other embodiments, computer software which implements the features of the present invention may be embodied on computer readable mediums and/or on various platforms, such as personal computers, servers, etc. Hence, the present invention should not be limited to the architecture shown in this figure.

In general, the present invention requires a mechanism for a user to enter search queries and review results returned in response thereto. Generally, this functionality may be provided in a conventional Web browser 12 or other search interface instantiated within a client computer system 14. There are many different ways of providing a user with an interface to enter a query, and the particular means chosen to fulfill this function is not critical to the present invention. Inasmuch as users have become accustomed to interfaces that provide for display of both textual and graphical information, however, a Web browser is regarded as an effective interface for use with the present invention. In various embodiments of the present invention queries may be entered by human users and/or by automated computer processes.

Conventional Web browsers generally provide access to Internet resources such as search engine 16 via a communication path that includes both hardware and software components. The nature of these components is well known in the industry and will not be described further herein, except to indicate that in addition to these conventional means, a personal search router 18 is introduced. The personal search router 18 may be regarded as a communication portal connecting the conventional Web browser 12 (and its associated hardware and software components) to various personalization modules configured in accordance with the present invention. Whereas in conventional computer systems the results returned by the search engine 16 may be routed directly to the Web browser 12, in the present case those results are diverted by the personal search router 18 to a personal search engine 20 for ranking according to the learned associations (which may be stored in a personal search vocabulary 22) discussed above. After such ranking the now personalized search results (sorted according to the dictates of the learned associations) are delivered by the personal search router 18 to the Web browser 12 for display to the user.

Examining this sequence in further detail, in the case of an Internet search query that query is made available to a conventional Internet search engine 16 (such as search engines provided by Google™, Yahoo™, or other commercial entities) via the personal search router 18. After or as results are returned from the search engine 16, the personal search router 18 sends the results (which at this time will be ranked according to whatever algorithms are used by the search engine 16) to the personal search engine 20 for personalized sorting. The personal search engine 20 computes a score (or other ranking criteria) for each result returned through the personal search router 18, which score is computed by an algorithm that uses the historical vocabulary information (i.e., the learned associations between prior search queries and selected results thereof) found in the personal search vocabularies 22.

Central to the search vocabulary information is a history of matches between query words (the user vocabulary) and the words of the matched or selected items in the returned result(s) (the Internet search engine vocabulary). Using this information, the personal search engine 20 reorganizes the ranking of the returned search results responsive to the present search query so as to personalize the order of those results according to the learned associations between prior query wording and selected results. The search vocabularies 22 are kept up to date by including further search query/selected result entries each time a search is made. In other embodiments, updates may be made less frequently. This updating of the personal search vocabularies 22 may be regarded as a form of learning through which associations between the text patterns between the user queries and the selected items are reinforced as frequently as whenever a new search result is selected.

After the personal search engine 20 determines scores using historical learned associations from the personal search vocabularies 22, it sends the personalized sorted list of results to the Web browser 12 via the personal search router 18. The Web browser 12 (acting as a user interface) then presents this list of sorted results to the user in the conventional fashion. Note that although the manner of presentation may be conventional, the arrangement of the results on the display may be less so, for example in the case when personalized search results are displayed in a list, matrix or other fashion selected by a user for receiving such information.

In order to manage various user options a personal search user interface module 24 that includes a user interface is incorporated in the present system. The user interface 24 (which may be a graphical user interface or a command line interface) provides a mechanism to capture, store and change user preferences and to create new vocabularies and purge old vocabularies. For example a user may select a length of the list returned from the Internet search engine to be personalized. The user may also select the rate of decay of memories and the rate of incorporation of new memories. The user may also choose to have multiple memories, each with specialized vocabularies for different domains of personal interest. Other options can be made available to the user for information presentation and other aspects of program operation. The personal search user interface 24 communicates with the other modules via the personal search router 18, though in other embodiments different communication paths may be used.

The methodologies and algorithms incorporated in the personal search engine 20 and personal search vocabularies 22 interact with one another to produce the personalized sorted results for display to the user. In particular, the personal search vocabulary 22 builds an associative memory of previous queries and the items selected by the user in response to the presentation of the sorted items. In general, each search query will generate a list of results which will be sorted. The first query will not have any historical information from which to be further personalized and so will be presented in the order returned by the Internet search engine. The user query will consist of one or more words supplied by the user and will be stored in the search vocabulary 22. Should the user select one or more of the results returned in response to this query, the search vocabulary is updated to reflect the association between the words in the selected search result with the words in the user's search query.

In one instance of the invention, this associative organization may be perceived as a conceptual two-dimensional grid with one axis thereof containing words from prior search queries entered by the user and another axis containing words from the search results returned in response to those queries and actually selected by the user. For example, assume a user has presented a search query made up of “Query Words” to a conventional search engine. That search engine will return a ranked list of results. Assume now that the user selects result “J” in that list. Then, the following association is presented to the associative memory:
<Query Words, Associated Response J>
   The “Associated Response” may be presented as a snippet (see below) or some other format, and the information set may be presented as a data pair. The associative memory may be instructed to regard each word or other characteristic of each data pair as an attribute in order to construct the associative grid. Conceptually then, a two-dimensional grid or matrix is available that can show the relationship of any attribute with any other attribute. Associations are therefore formed by showing co-occurrences or counts of intersections between each query word or attribute with each response word or attribute. As multiple pairs of queries and selected responses are presented to the associative memory the count of some associations increase, thereby showing a stronger association.

As new words arrive from new queries and responses, the size of the matrix continues to grow. It should therefore be apparent that the number of potential entries in the matrix becomes very large. However, since many of the entries in the matrix are empty (implying no association) the matrix is relatively sparse and, therefore, can be compressed. As indicated above, Saffron Technology, Inc. has developed a set of algorithms to efficiently compress such a sparse matrix and the use of such technology in embodiments of the present invention can dramatically decrease the required storage space for the associative memories. Nevertheless, because new associations are continually being added, at some point it becomes impractical to provide sufficient physical storage for the ever-growing matrix. Moreover, the need for rapid updates, retrievals and other operations involved with the matrix means that the size thereof should be kept manageable. In one embodiment this is achieved by a technique that allows the matrix to “forget” older associations in favor of new ones (e.g., much like human memory seems to operate).

Thus the present invention provides for recording associations between query works and selected search words and/or context. This recording of matched vocabularies (user vocabulary and search engine vocabulary) is referred to as developing an associational memory. Multiple search memories or vocabularies are feasible and can be controlled by the user to develop specific memory expertise for various specialized search purposes. It is feasible and appropriate for associations to decay over time and infrequent associations to be removed. This mechanism of “forgetting” allows more recent associations with similar frequency to carry higher association strength. Removing infrequent and old associations helps conserve computer memory and improves search efficiency and effectiveness.

As new query results are returned from the Internet search engine 16, the personal search engine 20 works in conjunction with the personal search vocabularies 22 to create the personalized sorting of these results. The personal search engine 20 essentially presents the key words from each search result (or, as discussed further below, potential advertisement wording) to the personal search vocabulary or memory 22, and does this sequentially; that is, one set of key words are considered at a time. The personal search vocabulary 22 returns an indication of the strength of association (i.e., a score) between the key words contained in the present search results and those query words that were previously utilized in other searches. The personalized search engine 20 then sorts the list of results returned by the Internet search engine utilizing this score, and, optionally other information (such as the initial list order which is based on a generic algorithm of the search engine) before returning the results to the Web browser 12 for display.

A more descriptive example of the operation of one embodiment of the present invention may be considered in the following context. Any query to a conventional Internet search engine will return a list of responses {R₁, R₂, R₃, . . . Rₙ}, and each such response will include a snippet together with some information regarding the corresponding web site:
Rᵢ=<Snippetᵢ, Site_Informationᵢ>
   A snippet may be regarded as a brief summary of a web site and generally includes a hypertext link thereto as well as some text that allows a user to determine the relevance of the site to the query originally presented. For example:
Snippet=<Descriptive Label as Hypertext link to URL, text, URL, other info>. Site_Information, which is optional, may include any information culled from the actual web site pointed to by the snippet; for example:

Site_Information=<First M words from paragraph at web site, Words from all headers first page, attributes (e.g., dates, number of pictures, categorical information, etc.>

Site_Information may be obtained using a computer program configured to access a web site and parse the information retrieved therefrom so as to capture that information within a particular syntax. The use of such automated processes (often referred to as Web crawlers or spiders) is well known in the art and, consequently, will not be described further herein. An attribute of Site_Information may be any item of information, such as a word, a word in a specific category, or other structured or unstructured data.

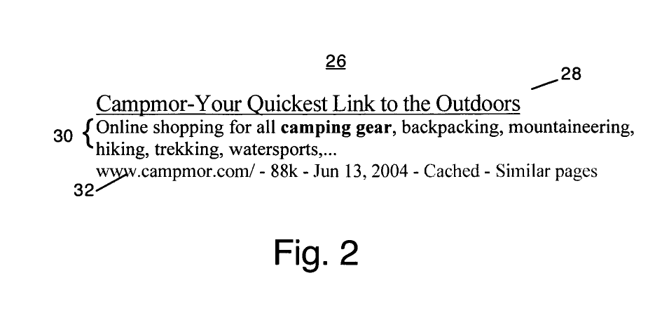

Thus, if a user is seeking to purchase camping gear the user may access a conventional Internet search engine and present an appropriate query, say “camping gear”. In response, the Internet search engine will return a set of results (often ranked according to some algorithm), among which may be a snippet 26 (see FIG. 2) for a website owned by a company called “Campmor” at a web address: www.campmor.com.

The snippet 26 includes a descriptive label 28 that typically is rendered in the browser as a hypertext link to a uniform resource locator (URL) for the web address of the associated merchant or content provider. Also included in snippet 26 is some text 30 that is usually chosen by the search engine so as to display the user's original search query in the context in which it is used at the web site represented by the snippet 26. Often the URL 32 is also displayed within snippet 26 and in some cases additional information may also be included.

The Site_Information from the Campmor web site (www.campmor.com) may be any information. For example, the Site_Information may include the first few words from the first paragraph at the web site (which in this case were found to be “Discontinued styles while they last . . . ”), the headers from the various pages that make up the web site (in this case “Packs”, “Tents”, “Clothing”, “Sleeping”, “Bicycling”, . . . ), or any other attributes from the web site.

In accordance with the present invention, the list of results returned by the Internet search engine (including the Campmor snippet 26) is provided by the personal search router 18 to the personal search engine 20. Assuming N such snippets are included in the list, the goal is to rank those N snippets in a personalized fashion (which will generally be some other fashion than that in which the results were returned by the Internet search engine) that reflects the learned associations developed from the user's prior searches and the selected results thereof. In one embodiment of the present invention this is achieved by determining, for each of the N snippets, a score that represents a strength of the association (based on the learned history of prior searches) between the query words (“camping gear”) and the snippet. The entire list of results may then be ranked according to those scores and the presented in the order so determined to the user. Algorithmically, the process resembles:
For I=1 to N
   Optional: goto the site of Snippet I and add specific Site_Information
   Optional: filter stop words (by, the, a) and remove stems (hills→hill)
   Optional: preprocess results to remove words with low differentiation
   Score I=Strength of Association <Query, ResponseI>
   Record Score I
Rank Scores
Sort Responses by Rank
Display sorted Responses

The strength of the association, in perhaps its simplest form, may be thought of as the sum of the grid counts (i.e., the number of intersecting results of query words and responses in the two-dimensional grid) of each possible association between the query words and the words in the response. Of course, relative scaling and absolute strengths of associations may be taken into account when determining the sort and/or confidence in the information in the sorting process. Furthermore, in addition to or in place of the use of query words as attributes, groups of such words and/or categories of such words may also be used. Likewise, it is not just the unstructured results that can be used as attributes of the associative memory. These results can be parsed in order to obtain structured data that can then be used as associative memory attributes. Software such as that provided by Inxight Software, Inc. of Sunnyvale, Calif. might be used for such purposes.

It is also possible to incorporate filters for use as part of the personalized raking process. For example, negative filtering may be used to eliminate snippets of undesirable web sites (such as those that might contain adult-oriented materials, for example). Filtering may be instantiated as a conventional “white list”/“black list” form of filter or it may be somewhat more sophisticated and instantiated as a learned negative association stored within the associative memory. Filtering can also be used to insure words that are unlikely to be useful in forming associations are ignored. For example, stop words such as “the”, “a”, “of” can be ignored as well as punctuation characters such as “,” and “?”. In addition words can be stemmed, so the main part of the word is retained and affixes are removed. For example, words that are plural can be made singular and common suffixes such as “ed” can be removed so that associations become more general. Also, the group of results can be preprocessed, for example to remove words that provide little differentiation between returned results. For example, any word that occurs in more than some threshold percentage of returned results, say 75% of results, can be ignored when forming new associations or ranking a list of returned results.

Of course, specialized memories may also be used to further refine the sorts of associations stored. For example, separate memories for personal (e.g., hobby-oriented) searches and professional (e.g., research-oriented) searches may be maintained. Temporary copies of memories may also be used so as to allow for “clean slates” to be developed when commencing new searches. In this way, new associations are not encumbered with old, possibly outdated associations that have not yet been forgotten.

In addition to the embodiments described above, a further implementation of the present invention provides a personalized search engine that returns suggested modifications to current search queries in order to return results anticipated to be more desirable. That is, based on a current search query and the associations generated thereby, the personal search engine may be configured to return a ranked list of words or phrases that may be added to or used in place of the original search query in order to prove more informative search engine returns than those presently available. This feature may be combined with an indication of which words from the current search query are not providing much useful impact in generating useful returns (e.g., those words which generate low associational scores).

The list of words to be added to or used in lieu of the existing search query may be generated by looking for those words in the associative memory having high associational scores associated therewith. If these terms are not already included in the query the personalized search engine may suggest their inclusion and even their usage within the context of an advanced search. In some cases, this suggestion may be augmented by having the Internet search engine actually execute such a search and the personalized search engine may return at least a partial list of the ranked results (personalized or not) retrieved as a result of that search. These new results may be presented in such a way as to allow the user to make a determination as to whether or not initiating a more extensive search along the suggested lines is in fact desirable. This may, in some examples, take the form of results presented alongside the current search query results, or in other cases, on a separate page from the current search query results. Any number of such alternative searches may be suggested and/or executed, but the total number should be kept to a manageable number so as not to overwhelm the user with results or unnecessarily tie up computer resources.

Still another embodiment of the present invention allows Internet (and other) search engine providers to either directly generate or improve the rankings for lists of results generated in response to a user query by accessing large group associative memories to take advantage of associations learned as a result of monitoring the queries and selections of large groups of their users. As is the case for the personalized search engines, the associative memories used by the Internet-based search engine providers maybe general purpose (e.g., having associations from all or a large portion of their users); special purpose (e.g., limited by user group, user interest, or other criteria); or even individual (e.g., offered as a per-user associative memory either free or for a fee). Various usage models for such a deployment exist, among them: use of the associative memories to replace current ranking algorithms, use of the associative memories to augment the current ranking algorithms (e.g., in order to modify the returned list of results or the ranking algorithms themselves), or use of the associative memories to rescore a partial list of the entirety of results returned by the conventional ranking algorithms.

As alluded to above, it is not only Internet search engine results that might be ranked according to the learned associations stored in the associative memories. Advertisements may also be so ranked and returned in sorted order in accordance with those rankings. Filters may be employed to specifically exclude any advertisements (or indeed to include only advertisements) in returned lists of results.

This ranking of advertisements (which may be performed at the internet search engine level, the ad server level or the personalized search engine level) is also useful when it comes to the actual design of the advertisements themselves. That is, advertising designers (i.e., those responsible for developing the ad content and or its context) may make use of the personalized search engines of the present invention to develop a virtual focus group. By studying the personalized result lists returned in response to search queries (and in such cases the internet search engine 16 may be replaced or augmented by a proprietary database), the advertising developers can learn which combinations of words or other content in their advertisements will yield highly ranked search results. Using this information the advertisements can be narrowly tailored to the target audience. Note that it is not only the content of the ad which may be so developed, but also parameters such as the advertisement size, its location on a web page and other contextual information.

Elements of the present invention described herein may be included within a client-server based system in which one or more servers communicate with a plurality of clients configured to transmit and receive data from the servers over a variety of communication media including (but not limited to) a local area network and/or a larger network (e.g., the Internet). Alternative communication channels such as wireless communication via GSM, TDMA, CDMA, Bluetooth, IEEE 802.11, or satellite broadcast are also contemplated within the scope of the present invention.

The servers may include databases storing various types of data. This may include, for example, specific client data (e.g., client account information and client preferences) and/or more general data. A user/client may interact with and receive feedback from the servers using various different communication devices and/or protocols. According to one embodiment, a user connects to the servers via client software that includes a browser application such as Netscape Navigator™ or Microsoft Internet Explorer™ on the user's personal computer, which communicates with the servers via the Hypertext Transfer Protocol (hereinafter “HTTP”). Among other embodiments, software such as Microsoft's Word, Power Point, or other applications for composing and presentations may be configured as client decoder/player. In other embodiments included within the scope of the invention, clients may communicate with servers via cellular phones and pagers (e.g., in which the necessary transaction software is electronic in a microchip), handheld computing devices, and/or touch-tone telephones. The servers may also communicate over a larger network to other servers. This may include, for example, servers maintained by businesses to host their Web sites, e.g., content servers such as “yahoo.com.”

It is also important to recognize that much, if not all, of the software implementation described herein can be replicated in hardware embodiments of the present invention and that such implementations are considered to be within the scope of the present invention. Associative memories may be implemented in hardware and such hardware added to conventional computer systems to provide the capabilities and functionality described herein. Consequently, the reader should consider the discussions above as being directed to functionality that may be present in computer hardware, software or combinations of both hardware and software. Furthermore, any or all of the associative memories described herein may be partitioned into sub-memories. For example, an associative memory for use in accordance with the present invention may include some or all of a complete memory, a negative memory, a blank memory, and special interest memories (as discussed above).

In the foregoing specification, the present invention has been described with reference to specific embodiments. It will, however, be evident that various modifications and changes can be made without departing from the broader spirit and scope of the invention as set forth in the appended claims. The specification and drawings are, accordingly, to be regarded in an illustrative rather than a restrictive sense.

1. A method, comprising sorting results returned in response to a search query according to learned associations between one or more prior search query search terms and selected results of said prior search queries.

2. The method of claim 1, wherein the results returned in response to the search query are returned from a publicly accessible search engine.

3. The method of claim 2, wherein the publicly accessible search engine comprises an Internet search engine.

4. The method of claim 3, wherein the results returned in response to the search query comprise advertisements.

5. The method of claim 1, wherein the results returned in response to the search query are ranked for presentation to a user.

6. The method of claim 1, wherein the learned associations are constructed according to similarities in text patterns between the one or more prior search query search terms and elements of the selected results of said prior search queries.

7. The method of claim 6, wherein the selected results of said prior search queries comprise results selected for further review by a user.

8. The method of claim 6, wherein the learned associations are modified over time so as to retain newer ones of the learned association and delete older ones of the learned associations.

9. The method of claim 1, wherein the learned associations between the one or more prior search query search terms and the selected results of said prior search queries are based on textual associations between a search vocabulary of a user and the user's selection of previously returned results of Internet searches using terms included in said search vocabulary.

10. The method of claim 9, wherein the search vocabulary is organized so as to be indicative of a frequency of matched key words and associated query words.

11. The method of claim 9, wherein the learned associations are modified over time so as to retain newer ones of the learned association and delete older ones of the learned associations.

12. The method of claim 1, wherein the learned associations between the one or more prior search query search terms and the selected results of said prior search queries are based on contextual locations of the prior search query search terms within the selected results of said prior search queries.

13. The method of claim 1, wherein the learned associations between the one or more prior search query search terms and the selected results of said prior search queries comprise one or more of: negative association, special interest associations, associations related to searches performed by groups of users, or associations related to searches performed by a single user.

14. A method, comprising ranking results returned in response to a new search query according to learned associations between attributes of prior search queries and attributes of search results returned in response to said prior search queries that were selected for further investigation.

15. The method of claim 14, wherein the learned associations are accessed from an associative memory configured to store said learned associations in such a fashion that newer ones of the learned associations replace older ones of the learned associations according to user defined criteria for such replacements.

16. The method of claim 15, wherein the attributes of the prior search queries comprise one or more of: words, groups of words, or categories of words.

17. The method of claim 15, wherein the attributes of the search results comprise snippets of Web sites.

18. The method of claim 15, further comprising presenting said results in ranked order to a user.

19. The method of claim 18, further comprising presenting, in addition to said results in ranked order, one or more suggestions for modified versions of said new search query according to associational scores between attributes of said modified versions of said new search query and said attributes of search results returned in response to said prior search queries that were selected for further investigation.

20. The method of claim 18, further comprising presenting, in addition to said results in ranked order, further lists of ranked search results obtained for modified versions of said new search query according to associational scores between attributes of said modified versions of said new search query and said attributes of search results returned in response to said prior search queries that were selected for further investigation.

21. The method of claim 14, wherein the attributes of said prior search results include some or all of: words, groups of words, categories of words, color or location of information, number or type of images, or other structured or unstructured information.

22. The method of claim 21, wherein the attributes of said prior search results are obtained from snippets of Web sites returned by a search engine in response to said prior search queries.

23. The method of claim 22, wherein said results are presented in ranked order.

24. The method of claim 22, wherein said results are presented in ranked order in combination with one or more suggestions for modified versions of the new search query.

25. The method of claim 22, wherein said results are presented in ranked order in combination with further lists of ranked search results obtained for one or more modified versions of the new search query.
